(19) United States
(12) Patent Application Publication
(10) Pub. No.: US 2003/0041632 A1
(43) Pub. Date: Mar. 6, 2003

(54) Door-locking device

(76) Inventor: Lou F. Del Nin, Toronto (CA)

Correspondence Address: Lou F. Del Nin, Suite # 720, 40 Sheppard Avenue West, Toronto, ON, M2N 6K9, CA

(21) Appl. No.: 09/930,687

(22) Filed: Aug. 16, 2001

(51) Int. Cl. E05B 65/00

(52) U.S. Cl. 70/93

(57) ABSTRACT

An improvement to Del Nin's security locking device outlined by U.S. Patent No. 5,983,680 issued Nov. 16, 1999 is described wherein the improvement comprises of new gearing arrangement and vertical deadbolt design so as to strengthen the device's vulnerability to forced breakage, and so that such locking device may operate on doors opening from either left or right sides of its door frame. This improved vertical deadbolt design additionally replaces need for any spring-like mechanisms prone to attack and vulnerable to wear and tear, with more sturdy bayonette latch mechanism resulting in solid precision control over deadbolt's vertical movement.

### BACKGROUND OF THE INVENTION

1. Field of Invention

Lou F. Del Nin, in his U.S. Pat. No. 5,983,680 issued Nov. 16, 1999 and entitled “Door Locking Device”, provided a unique security device comprising both horizontal and vertical deadbolts and significantly advancing the art of door-mounted security devices. The disclosures provided equipment and methods for engaging both horizontal and vertical deadbolts that could be engaged either simultaneously or independent of each other, and allowing one to even open the door with the vertical deadbolt still engaged. These disclosures merit a careful understanding and are incorporated by reference.

2. Description of Prior Art

Many devices are known to prevent forced entry through a partially open door, including door-mounted chain locks and floor-mounted doorstops which secure a completely closed door, or alternatively allowing such door to be opened a small amount while keeping it secured against forced entry.

The security locking device described by Del Nin's patent is unique in that it provides protection against forced entry both when the door is closed and also when the door is open by way of vertical bolt remaining mounted to the door, regardless of whether engaged or disengaged. An additional safety feature unique to Del Nin's U.S.-patented door-locking device is that potential intruders are prevented from removing the vertical bolt from a floor-plate aperture with the door remaining in partially-open position.

However, Del Nin's U.S.-patented device itself suffers three underlying deficiencies. First of all, key components of Del Nin's device are situated outside of its protective lock-box casing, and therefore vulnerable to physical attack by an intruder. Referring to reference numbers contained in Del-Nin's U.S. patent, vertical movement of knob 86 up and down C-shaped opening 88 takes place inside sleeve 84 rather than inside lock-box 30 whose casing offers greater protection in that it is significantly less exposed to attack because of its location higher up on the door and therefore farther from reach of attack by any potential intruder. As a result of its location situated outside lock-box 30 of that patent, isolated from its casing other supporting parts with which to share direct brunt of a potential intruder's attack, and its more easily accessibly location situated lower down on the door within reach of easy attack by potential intruder, positioning of knob 86 of that patent within sleeve 84 of that patent provides easier access to potential intruders capable of reaching around the door towards gaining entry through destruction of this weakest link in Del Nin's original U.S.-patented door-locking device.

Secondly, the door locking device described by Del Nin's U.S. patent is disadvantaged from fact that a door opening from the left side necessarily requires a door-locking device containing locking mechanism specifically designed for left-side opening doors, and vice versa. Therefore, manufacturers of such door-locking device would be required to produce and attach different locking mechanisms with different gearing arrangements depending on whether the door-locking device in question is being suited to a door opening from either the left or right side of a door frame. Similar difficulties ensue for both vendors of such device required to stock both left-sided and right-sided door-locking devices under separate label and inventory, along with additional cost and inconvenience faced by end-users of Del Nin's door-locking device who may be unable to re-install such door-locking device from previous residence to new residence where such newer residence employs a door hinged from opposite side of the door-frame.

Thirdly, Del Nin's U.S.-patented door-locking device is disadvantaged due to its reliance on a spring mechanism 79 of that patent for engaging and disengaging its vertical deadbolt 34 from open to closed position, and vice versa. Such a spring mechanism described by Del Nin's U.S. patent requires a larger, more expensive, and more unsightly lock box for use on such door locking device. Such spring mechanism also wears out over time, eventually interfering with smooth operation of the door locking device itself, and until such time that it is replaced at significant expense and inconvenience to the end-user. Finally, incorporation of such spring mechanism 79 allows an intruder to actually disengage vertical deadbolt 34 on their own by potentially reaching around a partially-opened door and manually pulling the vertical deadbolt out from the floor-plate's aperture upwards into inherent slack of spring mechanism 79.

Objects and Advantages

The present improvement addresses disadvantages of Del Nin's U.S.-patented device in a novel manner by providing a stronger, more secure, more compact, single ambidextrous locking-device that can be installed on all doors regardless of whether they are hinged from left or right sides of the door frame.

The security lock of the present improvement comprises an elongated bolt secured to a door and which is slidable in a direction parallel to one of its faces. The elongate bolt is extendable into at least one engaged position in which an end portion of the bolt extends into an aperture adjacent to the door, and similar to the deadbolt described by Del Nin's U.S. patent. Also like the deadbolt described by Del Nin's U.S. patent, complete removal of the bolt from this aperture allows the door to be opened completely.

However, unlike the deadbolt described by Del Nin's U.S. patent, this improved version comprises a bayonette latch mechanism attached directly onto vertical deadbolt 34, preferably mounted onto rivet 80 of that patent. A smaller square-shaped bolthead is mounted onto face of what is now a smaller gear replacement for second gear 78 of that patent, which bolthead slides horizontally within aperture of the bayonette latch mechanism when the smaller gear upon which it is mounted gets turned by a first larger gear, which first larger gear is turned by the user's key.

The V-shaped Spring-mechanism is Replaced

As a result of this improvement, the deadbolt described by Del Nin's U.S. patent need no longer incorporate any form of v-shaped or even any spring mechanism whatsoever. Accordingly, the door locking mechanism benefits from significantly improved durability and reliability due to its improved reliance on gears rather than spring mechanisms prone to deterioration over time and use. Also addressed is shortcoming of the spring's inherent slack that would actually allow an intruder means of manually lifting vertical deadbolt 34 out from its floor-plate aperture, no longer problematic following replacement of spring mechanism 79 with inflexible bayonette latch in this improved version.

Lock-box Casing can be Reduced in Size

As a further result of this improvement, lock-box casing can be diminished in size due to replacement of Del Nin's v-shaped spring mechanism with more compact second gear, bayonette latch mechanism, and square bolthead sliding horizontally within aperture of this bayonette latch mechanism. In its preferred version, this improvement additionally reduces size, cost, and unnecessary bulk of first gear 76 of Del Nin's U.S. patent by squaring off two adjoining outside surfaces of this first gear. Such smaller squared-off first gear is now feasible because such first gear no longer requires 360 degree movement due to greatly reduced rotation on smaller second gear now limited by affixed square bolthead whose travel is in turn confined by bayonette latch mechanism's limited horizontal aperture.

First of all, as a result of this improved configuration and smaller lock-box required, Del Nin's U.S.-patented door locking mechanism can now be manufactured more compactly which benefits users by more attractive door locking mechanism for their doors, and reduced cost due to fewer and smaller parts employed under the improved device. Secondly, this improvement further adds security in that a smaller lock-box casing is more easily and solidly attached to doors featuring indented moulding and other non-flat surfaces to which less than full surface-area of Del Nin's larger door-locking mechanism could meet flat against the door. Thirdly, manufacturing costs are reduced in that less material overall is required for manufacture of such improved door-locking mechanism. Finally, reversible design of improved bayonette latch mechanism means that upper lock-box portion of the door-locking device described by Del Nin's U.S. patent is rendered horizontally reverseable so as to accommodate both left and right hinged doors alike.

Fewer Parts are now Necessary

In addition to such improvement relating to gearing of Del Nin's door-locking device, preferred aspect of this improvement additionally does away with connecting rod 82 of that patent no longer necessary to connect v-shaped spring mechanism 79 no longer present in this improved version. Fewer parts employed in this improved door-locking device provides benefits of lower manufacturing costs, reduced vulnerability to intruder attack with weaker components connecting rod 82 and spring mechanism 79 of Del Nin's U.S. patent no longer employed, and overall ability to accommodate fewer number of parts into more compact lock-box casing less costly to manufacture, easier to mount flush onto moulded doors, and overall more attractive to end-users of the improved door-locking device.

### BRIEF SUMMARY OF THE INVENTION

In accordance with the present invention, an improved security device comprises a latch mounted onto a larger gear meshing with a smaller gear on which is mounted a square bolthead travelling horizontally through a bayonette latch, in turn attached to a vertical deadbolt, which in turn features a knob travelling vertically through C-shaped aperture carved out of tubular portion of said bayonette latch thereby engaging or disengaging said vertical deadbolt either simultaneously with or independent of a horizontal deadbolt, which horizontal deadbolt is in turn either engaged or disengaged by said latch mounted on said first gear.

### BRIEF DESCRIPTION OF THE SEVERAL VIEWS OF THE DRAWINGS

Drawing Figures

In order that this improved door-locking device may be readily understood, preferred embodiments of the invention will be described by way of example with reference to the accompanying drawings in which:

FIG. 1 is a perspective view of a preferred security lock of the present improved invention installed on a door;

FIG. 2 is a cut-away isolated view showing components of the lock-box's internal mechanism and related components of the improved door-locking device shown in FIG. 1.

Reference Numerals in Drawings

| | | | |
|---|---|---|---|
| 4 | door | 6 | inner face of door |
| 8 | hinges of door | 10 | door opening |
| 12 | floor | 14 | doorknob |
| 16 | horizontal deadbolt | 18 | vertical edge |
| 20 | security lock | 22 | lock-box mechanism |
| 24 | hand-operated latch | 26 | vertical deadbolt |
| 28 | floor-plate | 30 | aperture in floor-plate |
| 32 | saddle bracket | 34 | sleeve for vertical deadbolt |
| 36 | larger squared-off gear | 38 | smaller gear |
| 40 | knob mounted on smaller gear | 42 | square bolthead |
| 44 | bayonette latch | 46 | horizontal aperture |
| 48 | knob mounted on vertical deadbolt | 50 | c-shaped aperture |
| 52 | top position of c-shaped aperture | 54 | bottom position of c-shaped |
| 56 | bottom edge of door | | aperture |

### DETAILED DESCRIPTION OF THE PREFERRED EMBODIMENTS

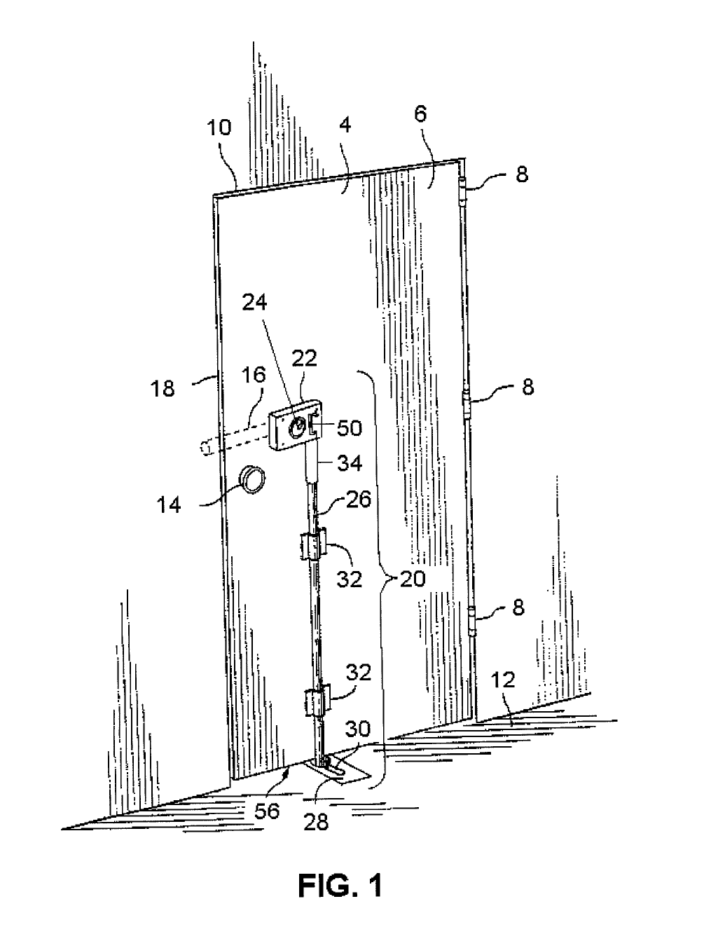

FIG. 1 illustrates a door 4 having an inner face 6 and an outer face (not shown) and being pivotably mounted on hinges 8 in a door opening 10 above a floor 12. Although door 4 is shown in FIG. 1 as being in a closed position, it is to appreciated that door 4 is pivotable in door opening 10 in a conventional manner to adopt both open and closed positions.

Door 4 is equipped with a doorknob 14 which operates a conventional lock set (not shown), as well as a conventional horizontal deadbolt 16 extending through the inside of door 4 and into an aperture (not shown) in a vertical edge 18 of the door opening 10.

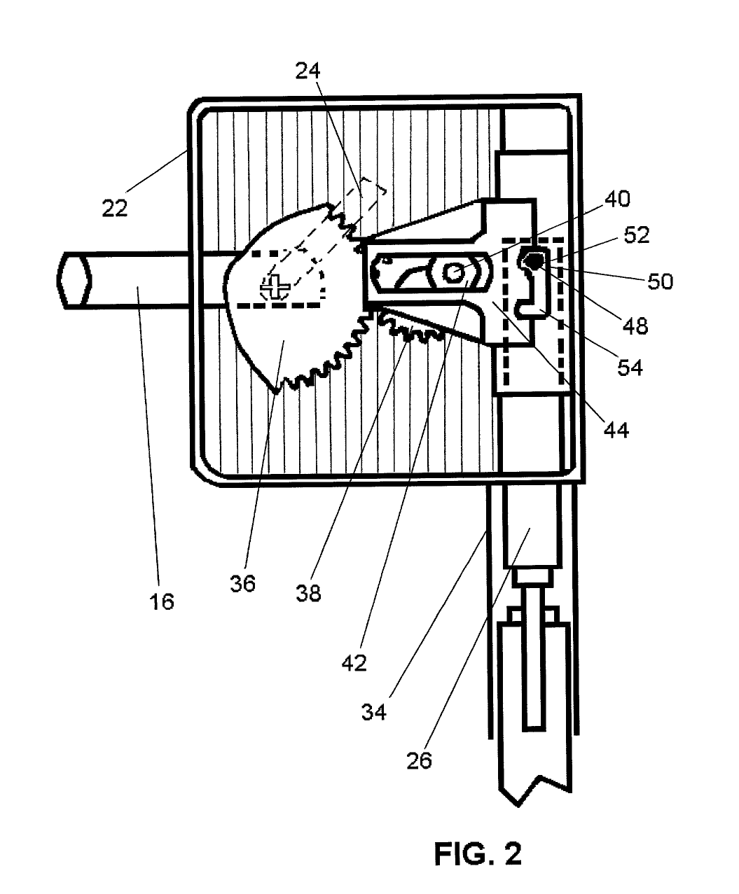

Also shown in FIG. 1 is a preferred security lock 20 according to the present improved invention. Security lock 20 comprises a lock mechanism 22 attached to the inner face 6 of door 4, a vertical deadbolt 26 extending vertically downwardly from lock mechanism 22, and a plate 28 attached to floor 12 and covering an aperture 30 in floor 12 into which vertical deadbolt 26 extends. Hand-operated latch 24, also shown in FIG. 2 in dotted lines, turns first gear 36 of FIG. 2 and also extends and retracts horizontal deadbolt 16 in a conventional manner.

The vertical deadbolt 26 is preferably made from a metal such as brass or steel, with a diameter of from about ⅜ to about ¾ inches, more preferably about 1 inch. Vertical deadbolt 26 has a preferred length of from about 30 to about 48 inches when used on a conventional sized door, and is typically from about 40 to about 42 inches long.

The vertical deadbolt 26 is secured to door 4 by at least one saddle bracket 32, and preferably two or more saddle brackets 32 as shown in FIG. 1. The brackets 32 are secured to the inner face 6 of door 4 and permit vertical sliding motion of vertical deadbolt 26 parallel to inner face 6 of door 4.

FIG. 2 illustrates improved lock mechanism 22 in isolation from the door 4 on which it is installed, and having its front cover cut away to reveal its internal parts. Lock mechanism 22 provides a means by which both the horizontal deadbolt 16 and vertical deadbolt 26 may be simultaneously engaged and disengaged. As shown in FIG. 2, lock mechanism 22 encloses two gears, a first gear 36 squared-off on two adjoining sides and connected to horizontal deadbolt 16, and a second smaller gear 38 on which square bolthead 42 sits atop knob 40 mounted on smaller gear 38. The square bolthead 42 slides within horizontal aperture 46 of bayonette latch 44, which bayonette latch 44 connects to vertical deadbolt 26 of improved security lock 20.

Hand-operated latch 24, shown in FIG. 2 in dotted lines, turns first gear 36 and also extends and retracts horizontal deadbolt 16 in a conventional manner. It is to be appreciated that hand-operated latch 24 may preferably be replaced by a key-operated latch (not shown), and that the outer face of door 4 is preferably provided with a key-operated latch mechanism (not shown) which turns first gear 36.

As shown in FIG. 2, first squared-off gear 36 and second smaller gear 38 mesh with one another such that rotation of first squared-off gear 36 rotates second smaller gear 38 in the opposite direction. This permits horizontal deadbolt 16 and vertical deadbolt 26 to be operated simultaneously by turning first squared-off gear 36.

As shown in FIG. 2, square bolthead 42 is mounted off-centre to the smooth side surface of second smaller gear 38, allowing such square bolthead 42 to travel left and right along horizontal aperture 46 of bayonette latch 44. The larger tubular-shaped end of bayonette latch 44 in turn forms a sleeve both wrapping around and attached to vertical deadbolt 26, and in such manner that entire bayonette latch 44 travels up and down in conjunction with vertical deadbolt 26, and within confines of sleeve 34 which sleeve surrounds upper portion of vertical deadbolt 26 for added stability.

Operation

As hand-operated latch 24 or any other form of key latch is turned in the lock mechanism, first squared-off gear 36 turns second smaller gear 38, causing square bolthead 42 to travel along horizontal aperture 46, placing vertical pressure through square bolthead 42 onto bayonette latch 44 so as to move entire bayonette latch 44 up or down to raise and lower vertical deadbolt 26 in and out from what is shown in FIG. 1 as aperture 30 of floor-plate 28 installed into surface of the floor.

With horizontal deadbolt 16 engaged (in the locked position) as shown in FIG. 1, vertical deadbolt 26 may either be in the first or second engaged position, thereby providing a second lock to prevent forced entry through door 4. When horizontal deadbolt 16 is disengaged (unlocked), vertical deadbolt 26 may either be in the first engaged position or in the disengaged position. Therefore, with horizontal deadbolt 16 unlocked, door 4 may either be opened partially, with vertical deadbolt 26 in the engaged position, or door 4 may be opened completely with vertical deadbolt 26 completely disengaged.

Therefore, vertical deadbolt 26 is capable of adopting two positions for each position of the horizontal deadbolt 16, and security lock 20 is preferably provided with a separate mechanism by which the desired position of vertical deadbolt 26 may be selected.

As shown in FIG. 2, the tubular-shaped end of bayonette latch 44 forms a hollow-sleeve around the upper end of vertical deadbolt 26. This hollow-sleeve portion of bayonette latch 44 preferably contains a C-shaped aperture 50 through which knob 48 which may preferably be threaded into or otherwise attached to vertical deadbolt 26 after the upper end of vertical deadbolt 26 is inserted into such hollow-sleeve portion of bayonette latch 44.

When knob 48 on vertical deadbolt 26 is received in the upper arm 52 of C-shaped aperture 50, as shown in FIG. 2, the lower-end of vertical deadbolt 26 has two possible positions, either engaged or disengaged, depending on the position of horizontal deadbolt 16. Preferably, knob 48 would be received in upper arm 52 of C-shaped aperture 50 when it is desired to de-activate the door-stop feature of security lock 20, so that when horizontal deadbolt 16 is unlocked, door 4 may be completely opened.

When knob 48 is moved through C-shaped aperture 50 to become received in lower arm 54, vertical deadbolt 26 is in either the first or second engaged position, depending on the position of horizontal deadbolt 16. Preferably, knob 48 is received in lower arm 54 of C-shaped aperture 50 when it is desired to use the door-stop feature of security lock 20. Specifically, with horizontal deadbolt 16 unlocked, vertical deadbolt 26 is in the first engaged position, so that door 4 may be partially opened within limits allowed by aperture 30 in floor-plate 28.

Conclusion, Ramifications, and Scope

Although this improved security lock according to the present invention has been described herein as being applied to a door, it is to be appreciated that this improved security lock design may preferably be used with other hinged structures, such as windows and gates. For example, this improved security lock may be provided in an inwardly opening casement window, with the improved bolt and lock mechanism being provided in or on the window sash and the floor-plate being provided in the window sill.

Although this improved security lock has been described as having a vertical deadbolt, it is to be appreciated that a security lock may be provided where, for example, the deadbolt extends horizontally into a slotted opening in the side jamb of a door opening. Furthermore, a security lock may be provided in which the deadbolt extends upwardly into a slotted opening above the door, for example, in the ceiling.

Although this improved security lock has been described as being applied to a door having a conventional horizontal deadbolt, it is to be appreciated that this is not necessary. The security lock of the present improved invention may instead be used on its own or in combination with any other type of door lock.

Although this improved security lock has been described in connection with certain preferred embodiments, it is not intended to be limited thereto. Rather it is intended that this invention cover all alternate embodiments as may be within scope of the following claims. This invention also includes all embodiments which are functional equivalents of the specific embodiments and features which have been described herein.

It will be further understood that, although various features of this invention have been described with respect to one or another of the embodiments of the invention, the various features and embodiments of the invention may be combined or used in conjunction with other features and embodiments of the invention as described herein.

What is claimed is:

1. In combination,
a door pivotally mounted in a door opening above a horizontal floor,
the door mounted in the door opening for pivoting about a vertical axis between open and closed positions in the door opening, the door having an outer face and an opposed inner face,
the door further having a lower edge proximate the floor, an elongate aperture in the floor adjacent to the door,
a security locking device comprising:
(a) elongate bolt secured to said door so as to be slidably mounted parallel to one of said faces, said bolt being extendable into a first engaged position wherein an end portion of the bolt extends outwardly of the lower edge of said door and into the elongate aperture in the floor; the bolt being substantially vertical relative the floor,
(b) locking means preventing withdrawal of said bolt from said aperture while said door is in an open position; and
(c) releasing means allowing said bolt to be inserted into, and withdrawn from, said aperture while said door is in a closed position,
wherein said bolt is movable in a lengthwise dimension of said elongate aperture by pivoting movement of said door, thereby permitting said door to be opened by a predetermined amount with said bolt in said first engaged position;
the bolt extends outwardly of said inner face of the door and is secured to the inner face of the door by at least one bracket permitting longitudinal sliding of the bolt therethrough;
said locking means comprises:
i. a plate covering said aperture and having an elongate opening, a width of the elongate opening being less than a width of the aperture;
ii. said end portion of said bolt having a diameter greater than the width of the elongate opening in the plate, wherein said end portion is received in said elongate aperture when said bolt is in said first engaged position; and
iii. an intermediate portion of the bolt adjacent said end portion having a diameter less than the width of the elongate opening in the plate, at least a portion of said intermediate portion of the bolt being in registry with the elongate opening of the plate when the bolt is in said first engaged position,
said releasing means comprises an enlarged opening in the plate having a width greater than the width of the elongate opening and greater than the diameter of the end portion of the bolt, said enlarged opening communicating with the elongate opening of the plate and being positioned so that when said door is closed, the end portion of the bolt may be withdrawn from and inserted into said aperture through said enlarged opening in said plate,
and wherein:
a first portion of the aperture, into which the bolt is extendable through the elongate
opening in the plate, has a first depth;
a second portion of the aperture into which the bolt is extendable through the enlarged opening in the plate, has a second depth;
the second depth is greater than the first depth;
in the first engaged position, the bolt extends into said aperture to a first engaged depth less than or equal to the first depth of the aperture; and
in a second engaged position, the bolt extends into said second position of the aperture to a second engaged depth greater than the first depth of the aperture, such that, when the bolt is in said first engaged position, the door is openable by a predetermined amount, and when said bolt is in said second engaged position, the door is closed.

2. The combination according to claim 1, wherein said enlarged opening communicates with an end of the elongate opening closest to the door opening.

3. The combination of claim 1, wherein said door has a first vertical edge connected by a hinge to an edge of the door opening, and a second vertical edge remote from said first vertical edge.

4. The combination of claim 3, wherein said aperture in said floor is proximate said second vertical edge of said door.

5. The combination of claim 3, wherein said bolt is raised from said first engaged position and lowered into said first engaged position by a first locking mechanism.

6. The combination of claim 5, wherein said first locking mechanism simultaneously controls a horizontal deadbolt extendable into an aperture in a vertical edge of said door opening.

7. The combination of claim 5, wherein said first locking mechanism is connected to an upper end of said bolt by a gear mechanism.

8. The combination of claim 7, in which said bolt contains a knob protruding by means of which height and consequent degree of penetration of said bolt through any aperture may be adjusted.

9. The combination of claim 7, wherein said gear mechanism comprises a latch mounted on one gear, which first gear meshes with any number of other gears, upon which of the other gears is mounted a protruding bolthead or other part travelling through aperture of a latch, which latch is in turn connected to said bolt.

10. The combination of claim 9, in which said bolt contains a knob protruding through said latch, and which arrangement provides means for adjusting height of said bolt and its consequent degree of penetration into any aperture when said gears are caused to turn.

11. The combination of claim 1, wherein the bolt is raised from said second engaged position to said first engaged position, and lowered from said first engaged position to said second engaged position, by a locking mechanism.
